(19) United States
(12) Patent Application Publication
(10) Pub. No.: US 2013/0283665 A1
(43) Pub. Date: Oct. 31, 2013

(54) Seat for Spinning Reel

(71) Applicants: Justin Poe, Mission Viejo, CA (US); David Brinkerhoff, Kelso, WA (US)

(72) Inventors: Justin Poe, Mission Viejo, CA (US); David Brinkerhoff, Kelso, WA (US)

(21) Appl. No.: 13/857,423

(22) Filed: Apr. 5, 2013

Related U.S. Application Data
(60) Provisional application No. 61/620,789, filed on Apr. 5, 2012.

(51) Int. Cl. A01K 87/06; A01K 87/08; A01K 87/00

(52) U.S. Cl. CPC A01K 87/06; A01K 87/00; A01K 87/08
USPC 43/22; 43/18.1 R; 43/23

(57) ABSTRACT

A handle for a fishing rod is provided. The handle is of multi-piece construction and comprises a reel seat for securely receiving a fishing reel of various types. Portions of the handle are secured together to selectively form a secure connection between a rod and a reel.

This Non-Provisional Application claims the benefit of priority from U.S. Provisional Patent Application Ser. No. 61/620,789 filed Apr. 5, 2012, the entire disclosure of which is hereby incorporated by reference in its entirety.

### FIELD OF THE INVENTION

The present invention relates to fishing rods and, more particularly, to a fishing rod handle portion for accommodating reels, including open faced spinning reels and reel feet of various forms.

### BACKGROUND OF THE INVENTION

Fishing rods are known to comprise a handle portion proximal to a user, the handle portion useful for manipulating the rod as well as securing a fishing reel. Fishing reels are provided in various forms, including spinning reels with a reel foot for contacting the handle portion.

Fishing rods and handles of the prior art suffer from a number of disadvantages, including conventional tubular reel seats where the reel foot does not sit firmly and the reel tends to rock from side to side. Another common fault with conventional reel seats is that lock nuts used to secure the reel to the rod may loosen due to handling when casting and fishing and must be periodically re-tightened. Rods and the associated reel and reel seat components are also susceptible to corrosion, primarily due to repeated water exposure, and this may complicate removal and/or application of the reel. Additionally, known rod and reel systems provide for a significant amount of contact between metal components and a user's hand. Such contact reduces comfort of the user experience, complicates a user's ability to grip the rod particularly in the presence of moisture, and poses a risk of contact with and loosening of adjustable or rotatable components.

Additional disadvantages of many rod and/or reels include manufacturing and economic disadvantages. For example, many conventional handle assemblies consist of ten or more parts that may include: an ornamental front cap or winding check; a foregrip; a reel seat having a minimum of four parts including the barrel or body, the fixed front hood, the sliding rear hood and at least one lock nut; reel seat bushings used to adapt the reel seat to the rod blank; a rear grip; and an ornamental butt cap. This lengthy and complicated list of seat assembly parts leads to greater expense in production and assembly and also increases the number of components that may be lost or corrode, requiring replacement.

The procedure for assembling the conventional spinning handle is also complex and unduly increases the cost of manufacturing the rod. The conventional handle assembly procedure for a spinning rod includes: cementing the bushings into the reel seat; sliding the rear grip down the rod blank and cementing into place; sliding the foregrip down the rod blank and cementing into place; sliding the front end cap down the rod blank and cementing into place; and lastly, cementing the rear grip into place.

Therefore, there is a desire for a less complex rod and reel seat assembly that is sturdier in everyday use and preferably less susceptible to corrosion.

### SUMMARY OF THE INVENTION

Each of the foregoing disadvantages is overcome by the apparatus and methods of this invention. Additionally, the apparatus and methods of this invention achieve other advantages discussed more fully below. The present invention contemplates a novel system, device, and assembly methods for a fishing rod handle portion for receiving a spinning reel seat.

The following references are hereby incorporated by reference in their entirety: U.S. Pat. No. 4,077,150 to Barnes, U.S. Pat. No. 4,187,633 to Ohmura, U.S. Pat. No. 4,403,439 to Wallace, U.S. Pat. No. 4,432,155 to Miller, U.S. Pat. No. 5,377,441 to Noda, and U.S. Patent Application No. 2009/0255167 to Mullane.

One aspect of the invention is a fishing rod handle and associated components for securely attaching a fishing rod to a reel. One of skill in the art will recognize that a wide array of materials may be used in the construction of rod handles, including, but not limited to those described in the references incorporated by reference herein. Outer or user-interfacing portions of handles of the present disclosure may comprise cork, rubberized cork, pliable plastics, rubber cement with cork particles, etc. Such materials are preferably provided at least in high impact areas of the handle, such as front and rear portions of a forward portion, rearward portion, and butt portion of the handle. While natural cork is preferred in various embodiments due to its advantageous density and workability, various alternatives may be provided in combination with, or in lieu of natural cork. Various portions of the handle comprise closed cell foam(s) and EVA foam, particularly low impact areas of the handle.

In various embodiments, a butt portion is provided on a user-proximal end of the handle. Butt portions of the present disclosure provide numerous advantages, including, for example, overall balancing effects for the handle and/or rod and the ability to replace the user-proximal portion of the handle (which may be subject to high impact and/or abuse when the rod is set down). In various embodiments, a butt portion of the present disclosure further comprises internal features, such as a nut portion for receiving additional handle components. In one embodiment, an internal portion of the butt comprises a female threaded or nut portion for receiving a forward portion of the handle. Selective securement of at least these two features provides the ability to compressively secure a reel seat to the handle.

One embodiment of the invention provides a handle for a fishing rod, the handle comprising a forward portion comprising a first threaded member and a rearward portion comprising a second threaded member. The forward portion and the rearward portion are selectively interconnected by the first threaded member and the second threaded member, and the forward portion and the rearward portion define an area for securely receiving a seat of a fishing reel when the forward portion and the rearward portion are connected. Additionally, an elongate recess and an elongate protrusion may be provided, the elongate recess receiving the elongate protrusion when the forward portion and the rearward portion are disposed in a predetermined alignment, thereby allowing interconnection of said forward portion and said rearward portion in the proper (i.e. properly aligned) manner. In one embodiment, an elongate recess is provided on an interior portion the forward portion and the elongate protrusion is provided on an interior portion of the rearward portion. A plurality of recesses and corresponding protrusions may be provided on handles of the present disclosure. Recesses and protrusions may alternatively be referred to herein as key ways and keys, respectively. It will be expressly recognized that such features are not limited to any particular dimension, shape or orientation. Indeed, it is contemplated that such features may be provided as generally elongate rectilinear shapes, or any other shape(s) suitable for mating and ensuring a predetermined alignment of rod components.

In various embodiments, a handle for a fishing rod is provided where the rearward portion comprises a butt portion with an interior surface, the interior surface comprising a threaded member or nut portion for securing additional handle components.

Various embodiments of the present disclosure provide for an ergonomic grip. An ergonomic grip surface is achieved through, for example, the provision of cork to reduce user-contact with metal surfaces and provide a comfortable gripping surface.

These and other advantages will be apparent from the disclosure of the invention(s) contained herein. The above-described embodiments, objectives, and configurations are neither complete nor exhaustive. As will be appreciated, other embodiments of the invention are possible using, alone or in combination, one or more of the features set forth above or described in detail below. Further, the summary of the invention is neither intended nor should it be construed as being representative of the full extent and scope of the present invention. The present invention is set forth in various levels of detail in the summary of the invention, as well as in the attached drawings and the detailed description of the invention, and no limitation as to the scope of the present invention is intended to either the inclusion or non-inclusion of elements, components, etc. in this summary of the invention. Additional aspects of the present invention will become more readily apparent from the detailed description, particularly when taken together with the drawings.

### BRIEF DESCRIPTION OF THE DRAWINGS

Those of skill in the art will recognize that the following description is merely illustrative of the principles of the disclosure, which may be applied in various ways to provide many different alternative embodiments. This description is made for illustrating the general principles of the teachings of this disclosure invention and is not meant to limit the inventive concepts disclosed herein.

The accompanying drawings, which are incorporated in and constitute a part of the specification, illustrate embodiments of the disclosure and together with the general description of the disclosure given above and the detailed description of the drawings given below, serve to explain the principles of the disclosures.

It should be understood that the drawings are not necessarily to scale. In certain instances, details that are not necessary for an understanding of the disclosure or that render other details difficult to perceive may have been omitted. It should be understood, of course, that the disclosure is not necessarily limited to the particular embodiments illustrated herein. Various figures included herewith provide dimensions. It will be understood that dimensions used with the figures are merely exemplary and are provided for purposes of additional support and clarification. Such dimensions are not intended to limit the present disclosure in any way and should not be read as limiting or necessary features of any embodiment.

FIG. 1 is a partially exploded cross-sectional elevation view according to one embodiment of the invention.

FIG. 2 is a partially exploded front elevation view according to one embodiment.

FIG. 3A is a partially exploded top plan view according to one embodiment.

FIG. 3B is a partially exploded front elevation view according to one embodiment.

FIG. 3C is a partially exploded cross-sectional front elevation view according to one embodiment.

FIG. 4A is a cross-sectional front elevation view of a handle according to one embodiment.

FIG. 4B is a cross-sectional side elevation view of a handle according to one embodiment.

FIG. 4C is a detailed view of the embodiment of FIG. 4B.

FIG. 5A is a front elevation view of a handle according to one embodiment.

FIG. 5B is a cross-sectional elevation view of a handle according to one embodiment.

### DETAILED DESCRIPTION

To acquaint persons skilled in the pertinent arts most closely related to the present invention, a preferred embodiment of the method that illustrates the best mode now contemplated for putting the invention into practice is described herein by, and with reference to, the annexed drawings that form a part of the specification. The exemplary method is described in detail without attempting to describe all of the various forms and modifications in which the invention might be embodied. As such, the embodiments described herein are illustrative, and as will become apparent to those skilled in the arts, can be modified in numerous ways within the scope and spirit of the invention.

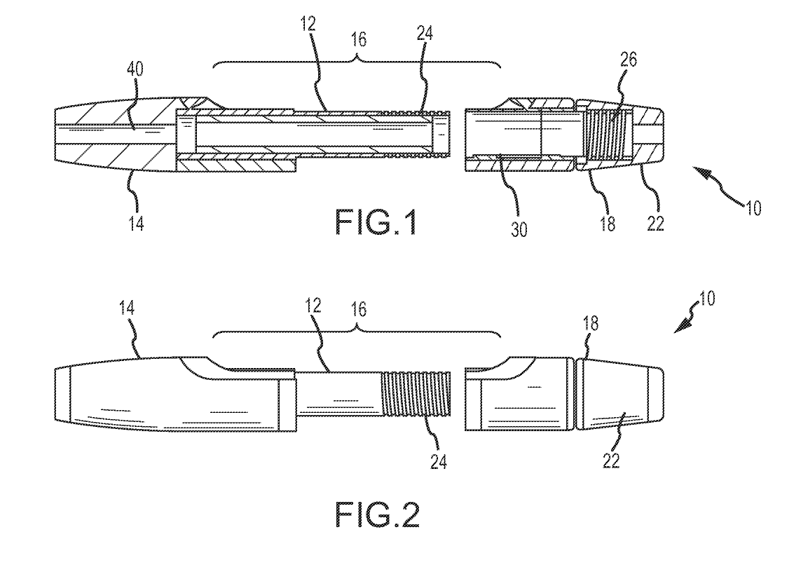

Referring to FIGS. 1-5, a handle portion for a fishing rod according to various embodiments of the present invention is shown. It should be understood that the drawings are not necessarily to scale. In certain instances, details that are not necessary for an understanding of the invention or that render other details difficult to perceive may have been omitted from these drawings. It should be understood, of course, that the invention is not limited to the particular embodiments illustrated in the drawings.

Referring to FIGS. 1-2, a handle portion 10 according to the present disclosure is provided, the handle portion 10 adapted to receive a fishing reel (not shown). It will be appreciated that the particular type of reel used with the handle portion 10 forms no part of the invention and that the handle portion may therefore be used either with a casting reel, a top mounted spinning reel, or various other reels, as recognized by one of skill in the art. Similarly, it will be appreciated that the specific type of rod used with features and devices disclosed herein is not critical. It is contemplated that such features and devices may be provided in combination with any number of type, material, weight, and/or dimension of rod. By way of example only, it is contemplated that handle and reel seat features of the present disclosure may be used in combination with a 3 weight fly rod, a 15-foot heavy action surf rod, or various other rods designed for specific fishing applications as will be recognized by one of ordinary skill in the art.

The components of the handle portion are preferably constructed from a light-weight material such as cork, plastic, aluminum, or various combinations thereof. The handle portion comprises a forward portion 14, an intermediate reel seat portion 16, a rearward portion 18, and a butt cap 22. The forward portion 14 and rearward portion 18 extend into the opposite ends of the reel seat portion 16 and are dimensioned to engage one another when so positioned in order to provide a solid interconnection between the various portions of the handle assembly 10.

In the embodiment depicted in FIG. 1, the forward portion 14 of the rod handle 10 comprises a press fit portion 12 which is secured to and extends rearwardly from the forward portion 14. The press fit portion 12 comprises securing means for joining the forward 14 and rearward 18 portions. The press fit portion 12 preferably comprises a hollow internal portion for receiving at least a portion of a rod blank 40. Although the press fit portion is depicted and described herein as being secured to a forward end of the handle 10, it will be recognized that this portion may alternatively be secured to a rearward portion 18.

As used herein, the term rod blank or blank refers to the elongate portion of a rod, to which rod components, such as eyelets, handles, reels, etc. may be connected to form a complete or partially complete rod. It will be expressly recognized, however, that features of the present invention are not limited to use with any specific type or style of rod blank and may be employed with a wide range of blanks and rods.

Handles of the present disclosure may be used with a variety of fishing rod Blanks. Internal dimensions of the handle features may thus be varied to accommodate any number of weight, thickness, or gauge rods. Inserts may also be provided to achieve this variation.

In various embodiments, a rod blank 40 extends through the butt cap portion 22 along a longitudinal axis and generally terminates at a user end provided with an additional cap feature. A portion of the rod blank 40 between the butt cap 22 and the additional cap feature may be generally exposed. Such an exposed portion and associated additional cap feature may provide for additional durability of the rod, such that a user-proximal end can be placed on a surface without risk of damage to various rotatable features, such as the butt cap 22.

In various embodiments, the butt cap feature 22 comprises one or more features for securing a rotational position of the butt cap 22 and preventing or minimizing inadvertent movement of the butt cap 22. For example, it is contemplated that the butt cap 22 comprises at least one rotation-limiting feature selected from a group comprising a ratchet and pawl, a biased détente or bearing mechanism, a cam lock, or similar feature for preventing rotation of the butt cap in an undesired direction. One of skill in the art will recognize that such an undesired direction may comprise either one of two rotational directions, depending on desired use. As such, the rotation-limiting feature may be reversed or deactivated.

To secure a reel within the reel seat portion 16, a reel seat is disposed between the forward 14 and rearward 18 portions and these portions are subsequently and threadably joined together such that the seat is compressed between the portions of the handle 10. The seat and associated reel are thereafter secured on the handle 10 and rod in a manner suitable for fishing operations.

The forward portion 14 and the reel seat portion 16 extend along a common longitudinal axis which passes generally through the center of the rod blank 40. As a result, the rod is sufficiently spaced from the reel to prevent rubbing when the rod bows.

In various embodiments, the press fit portion 12 comprises a male threaded portion 24 for communicating with an internal female threaded portion 26. Communication between the male 24 and female 26 threaded portions serves to contract the reel seat portion and compress and secure a reel seat when such a component is disposed therein. Such compression serves to selectively secure a reel seat and oppose movement of the reel seat in a number of directions such that a stable reel/rod combination is formed.

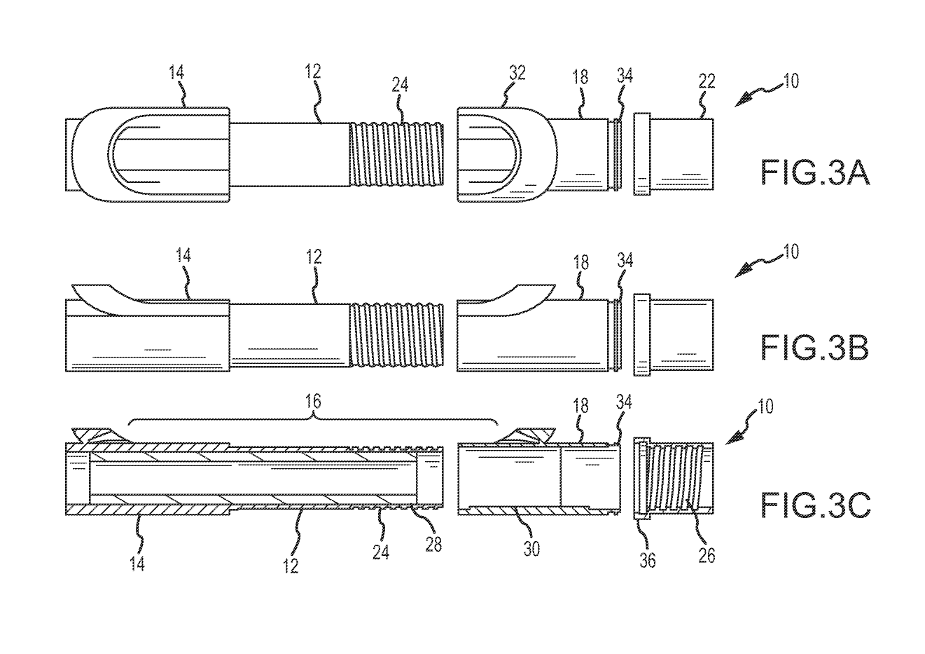

In various embodiments and referring to FIGS. 3A-3C, a key way 28 is provided, the key way 28 extending longitudinally along at least a portion of the male threaded portion and sized to receive a key 30, the key extending along at least a portion of the rear part 18 of the handle 10. In a preferred embodiment, the key way 28 is provided as a recessed slot. The combination of the key way 28 and key 30 requires a specific orientation and relative positioning of the forward 14 and rear parts 18 in order to assemble the handle. This orientation preferably corresponds to an orientation in which the reel seat portion 16 is assembled in a properly aligned manner. Various embodiments of the present disclosure contemplate more than one key/keyway combination. For example, the key/keyway combination could be oriented such that it is located under the reel foot within the reel seat portion 16. In another embodiment, a plurality of keys may be provided on a rearward end 18 with a corresponding number and structure of key ways provided on the forward end 14.

FIGS. 3A-3C provide an exploded top elevation view, an exploded front plan view, and an exploded cross-sectional plan view of a handle portion 10 according to one embodiment. As shown, the forward portion 14, rear portion 16 and butt portion 22 are shown in an aligned but disassembled state. A reel seat portion 16 is provided generally between the forward portion 14 and the rear portion 16. An at least partially arcuate portion 32 is provided, the at least partially arcuate pocket 32 defining a boundary of the reel seat portion 16. The at least partially arcuate pocket 32 is shown in FIGS. 3A-3C as extending generally above an outer surface of the forward 14 and/or rear 18 portion. This pocket 32, however, may be flush with an outer handle surface, particularly where the handle comprises a cork overlay as depicted in FIGS. 1-2.

The butt portion 22 shown in the embodiment provided in FIGS. 3A-3C comprises a cap with an internal annular groove 36 for receiving an annular rib 34 on a proximal end of the rear portion 16 for rotatably interconnecting the butt portion 22 and the rearward portion 18. It will be expressly recognized, however, that the groove 36 and rib 34 may be reversed such that the groove 36 is disposed on the rear portion 16 and the rib 34 is disposed on the cap portion. In various alternative embodiments, the groove and rib features are not provided, and the butt cap 22 is secured to additional components by way of the threads within the cap and corresponding threads of the rear portion. In various embodiments, a reel handle and seat portion are assembled and a reel foot compressed within a portion of the device by threaded communication between the butt cap portion and the rear portion, wherein rotational alignment of the assembled component is achieved by the mating of a key and key way provided at predetermined locations.

The butt portion 22 further comprises an internal threaded nut or female member 26 for securely receiving male threaded portion 24 of the forward end 14. In various embodiments, a nut for receiving the male threaded portion 24 may be provided separately from the butt portion 22. The embodiment of FIGS. 3A-3C, however, provides a butt member 22 with a nut member or female threaded portion 26 formed integrally therewith. Additionally, and as shown in FIG. 3C, a key portion 30 is provided along a bottom portion of the rearward portion 18. The key portion 30 mates with a key way 28 of the forward portion 14 to help ensure proper alignment of the reel seat 16 and arcuate pocket 32, for example.

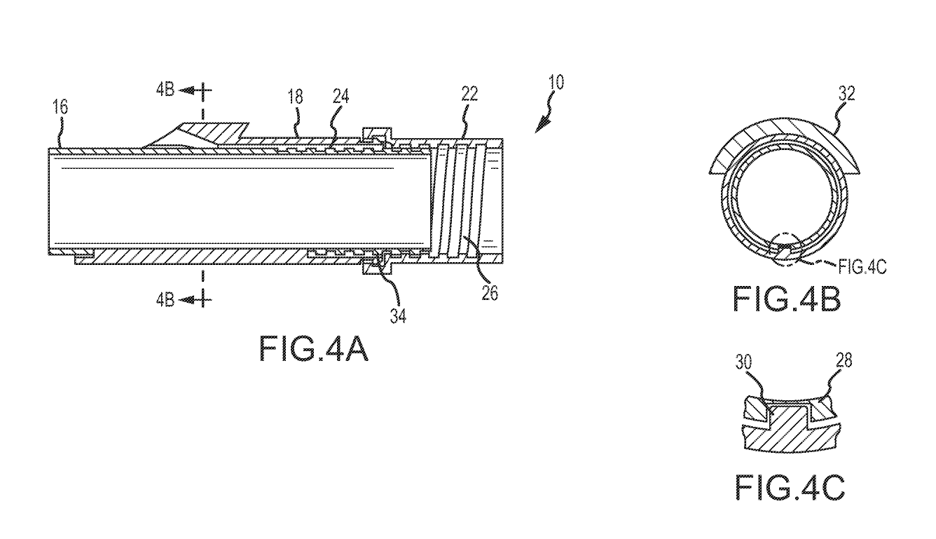

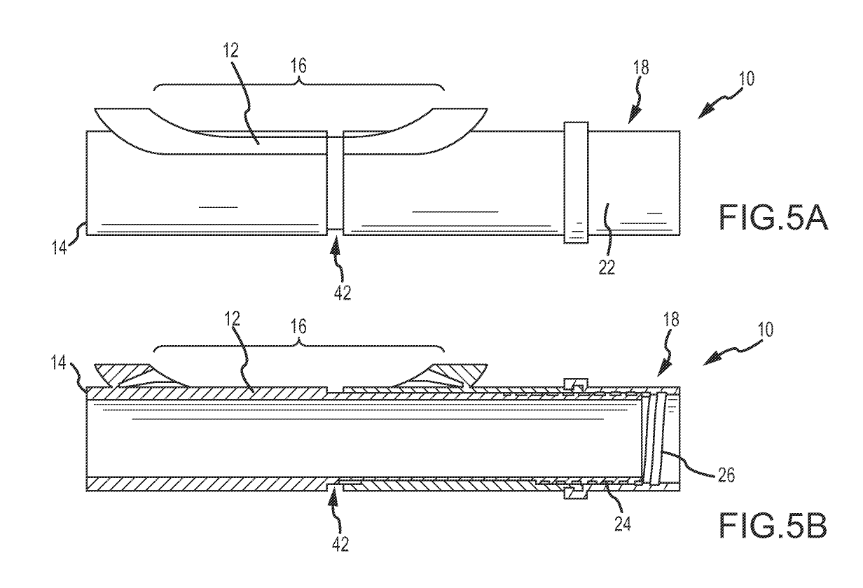

FIGS. 4A-4C provide a cross-sectional detailed front view, a cross-sectional side view, and a detailed cross-sectional side view, respectively. FIG. 4A depicts the handle 10 in a generally assembled state with the male threaded portion 24 interconnected with the female threaded portion 26. FIG. 4B is a cross-sectional view of the assembled handle at the location indicated by FIG. 4A. FIG. 4C is a detailed view of the region indicated in FIG. 4B wherein the key portion 30 is mated with the key hole 28 of the forward portion. Although the press fit portion 12 is generally described as being fit within the forward portion 14 of the handle 10, it will be recognized that this arrangement may be altered such that, for example, the press fit portion is disposed within the rearward portion 18.

Referring now to FIGS. 5A-5B, an assembled portion of a rod handle 10 is shown. FIG. 5A is a side elevation view where forward 14 and rearward 18 portions are joined by features shown and described herein. The reel seat portion is depicted without the inclusion of a reel. When fully compressed or engaged, outer portions of forward 14 and rearward 18 portions of the handle are separated by a gap or spacing 42. Gap 42 is preferably provided to ensure that reel seats of various dimensions may be secured between handle portions.

Gap 42 thus effectively ensures that contact between forward 14 and rearward 18 portions will not comprise a limiting factor whereby reel seats of a certain dimension cannot be securely received. In various embodiments, a handle 10 is provided wherein a fully assembled state comprises a gap 42 of between approximately 0.050 inches and 0.250 inches. In a preferred embodiment, a handle 10 is provided wherein a fully assembled state comprises a gap 42 of between approximately 0.10 inches and 0.20 inches. In a more preferred embodiment, a handle 10 is provided wherein a fully assembled state comprises a gap 42 of approximately 0.125 inches.

FIG. 5B is a cross-sectional view showing internal components of the handle 10, including threaded female portion 26 and threaded male portion 24 securely interconnected.

In one embodiment, a handle 10 is provided and dimensioned such that an approximately ⅛″ gap 42 is provided when a Shimano ® 2500 reel is secured within the handle portions 14, 18. A step or shelf portion may be provided, for example, in the key and key way combination, such that at least an outer diameter portion of the forward portion 14 and rearward portion 18 are prevented from contacting one another.

In various embodiments, key 30 and key way 28 comprise various different arrangements. It will be recognized that the key and key way structures are provided to perform at least one of the functions of guiding or dictating alignment of handle portions and generally limiting the extent to which forward and rearward portions of the handle may be drawn together. Accordingly, key and key way structures of various different forms may be provided in various different locations on a handle 10.

Each publication or patent cited herein is incorporated herein by reference in its entirety.

While various embodiments of the present invention have been described in detail, it is apparent that modifications and alterations of those embodiments will occur to those skilled in the art. However, it is to be expressly understood that such modifications and alterations are within the scope and spirit of the present invention. Further, the invention(s) described herein are capable of other embodiments and of being practiced or of being carried out in various ways. In addition, it is to be understood that the phraseology and terminology used herein is for the purposes of description and should not be regarded as limiting. The use of “including,” “comprising,” or “adding” and variations thereof herein are meant to encompass the items listed thereafter and equivalents thereof, as well as, additional items.

What is claimed is:

1. A fishing rod comprising:
a fishing rod shaft;
a rearward portion having an interior surface and a longitudinal cavity defined therein;
a forward portion secured to the rod shaft;
the forward portion comprising a first end and a second end, the rod shaft extending longitudinally from the first end;
the second end of the forward portion adapted to be received within the longitudinal cavity;
at least one of the rearward portion and the forward portion including a key, and the other portion including a longitudinal groove for slidably receiving the key.

2. The fishing rod of claim 1, wherein the key is attached to the rearward portion.

3. The fishing rod of claim 1, wherein the key is attached to the forward portion.

4. The fishing rod of claim 1, further comprising a butt cap rotatably secured to the rearward portion.

5. The fishing rod of claim 1, wherein the forward portion comprises a first half of a reel seat and the rearward portion comprises a second half of a reel seat.

6. The fishing rod of claim 4, wherein the second end of the forward portion comprises a first threaded portion engageable with a second threaded portion provided on an interior portion of the butt cap.

7. A reel seat for a fishing rod, comprising:
a forward portion comprising a first threaded member;
a rearward portion comprising a second threaded member;
the forward portion and the rearward portion being interconnected by the first threaded member and the second threaded member;
the forward portion and the rearward portion defining an area for securely receiving a fishing reel when the forward portion and the rearward portion are connected; and
an elongate recess and a protrusion, wherein the elongate recess receives the protrusion when said forward portion and said rearward portion are disposed in a predetermined alignment, thereby allowing interconnection of said forward portion and said rearward portion.

8. The reel seat of claim 7, wherein the elongate recess is provided on an interior portion the forward portion and the protrusion is provided on an interior portion of the rearward portion.

9. The reel seat of claim 7, wherein the elongate recess is provided on an interior portion the rearward portion and the protrusion is provided on an interior portion of the forward portion.

10. The reel seat of claim 7, wherein the rearward portion comprises a butt portion with an interior surface, the interior surface comprising the second threaded member.

11. The reel seat of claim 7, wherein at least a portion of a fishing rod shaft is disposed within the forward portion and provided substantially coaxially therewith.

12. The reel seat of claim 7, wherein a forward portion of the area for securely receiving a fishing reel is provided on the forward portion, and a rearward portion of the area for securely receiving a fishing reel is provided on the rearward portion.

13. A fishing rod comprising:
a reel seat comprising a first end and a second end, the reel seat adapted for receiving and compressibly securing a fishing reel;
a forward portion with a rod shaft extending therefrom;
a rearward portion provided substantially coaxial with the forward portion; and
the first end of the reel seat provided on the forward portion;
the second end of the reel seat provided on the rearward portion;
the forward portion and the rearward portion being slideably engageable with one another;
at least one of a protrusion and a longitudinal recess provided on the rearward portion and adapted for aligning the first end and the second end of the reel seat.

14. The fishing rod of claim 13, wherein the rearward portion comprises a protrusion.

15. The fishing rod of claim 13, wherein the rearward portion comprises a longitudinal recess.

16. The fishing rod of claim 13, further comprising a butt cap rotatably secured to the rearward portion.
